(19) United States
(12) Patent Application Publication
(10) Pub. No.: US 2025/0290603 A1
(43) Pub. Date: Sep. 18, 2025

(54) APPARATUS AND METHOD FOR DETERMINING AN AMOUNT OF COMPRESSED GAS

(71) Applicant: Thilo RIESSNER, Lichtenfels (DE)

(72) Inventor: Thilo RIESSNER, Lichtenfels (DE)

(21) Appl. No.: 19/225,328

(22) Filed: Jun. 2, 2025

Related U.S. Application Data
(63) Continuation of application No. PCT/EP2023/083190, filed on Nov. 27, 2023.

(30) Foreign Application Priority Data
Dec. 2, 2022 (DE) 10 2022 213 032.4

(51) Int. Cl. F17C 13/02; G01F 22/02; G01F 25/00

(52) U.S. Cl. CPC F17C 13/025; F17C 13/026; G01F 22/02; G01F 25/0084; F17C 2250/032; F17C 2250/043; F17C 2250/0439

(57) ABSTRACT

A measuring apparatus determines an amount of compressed gas in a gas withdrawal from a compressed-gas reservoir having sub-reservoirs capable of being tapped independently of one another. A gas pressure sensor is coupled with respect to pressure to each sub-reservoir by measurement lines. A switching device in the measurement lines can alternately connect the gas pressure sensor to each sub-reservoir to selectively measure a gas pressure in a sub-reservoir. At least one temperature sensor for measuring a gas temperature is disposed at a location of the compressed-gas reservoir. An associated method for determining an amount of compressed gas in a gas withdrawal from the compressed-gas reservoir calculates the amount of gas withdrawn by using measurement values of the gas pressure and the gas temperature captured by the measuring apparatus before the gas withdrawal and after the gas withdrawal.

### CROSS-REFERENCE TO RELATED APPLICATION

This application is a continuation, under 35 U.S.C. §120, of copending International Patent Application PCT/EP2023/083190, filed Nov. 27, 2023, which designated the United States; this application also claims the priority, under 35 U.S.C. §119, of German Patent Application DE 10 2022 213 032.4, filed Dec. 2, 2022; the prior applications are herewith incorporated by reference in their entirety.

### FIELD AND BACKGROUND OF THE INVENTION

The invention relates to an apparatus and to a method for determining an amount of compressed gas, in particular hydrogen gas.

Manufactured or industrial gases are usually stored under pressure in appropriate compressed-gas containers and transported from the place of manufacture to the place of use. For transporting larger amounts of gas, such as are required for industrial purposes or gas filling stations, such compressed-gas containers are generally mounted fixedly on a tank vehicle or trailer. In particular for transporting hydrogen, tank trailers are used which have a plurality of gas cylinders. As such, those gas cylinders are often interconnected to form bundles of cylinders (cascades), the bundles of cylinders being capable of being tapped independently of one another. Such tank vehicles or trailers are usually driven to the place of use in a filled state and, after emptying, are returned to a source, in particular the place of manufacture or an intermediate storage facility, for refilling.

However, when employed under real-world conditions, reliably and accurately determining an amount of such larger amounts of gas is technically complex due to the physical and chemical properties of the compressed gases transported.

In many cases, the gas consumption (i.e., the amount of gas withdrawn) is charged by measuring the pressure difference between the initial (gas) pressure in the filled compressed-gas containers before the start of the gas withdrawal and the final (gas) pressure in the completely or partially emptied compressed-gas containers after completion of the gas withdrawal. The amount of gas withdrawn is calculated by using the gas equation from the pressure difference determined, taking into account the volume of the container (i.e., the volume of the compressed-gas containers from which the gas was withdrawn) and an assumed average reference temperature. A disadvantage of that measuring method is high inaccuracy caused by the temperature dependence of the gas pressure. If the final pressure was measured at a higher temperature than the initial pressure, the amount of gas actually consumed will be underestimated. If, on the other hand, the final pressure is measured at a lower temperature than the initial pressure, the amount of gas actually consumed will be overestimated.

In order to enable a more accurate determination of the gas consumption, mass flow meters based on the Coriolis principle (Coriolis flow meters) are sometimes used. However, Coriolis flow meters with sufficient measurement accuracy are associated with high acquisition costs, which often make their use uneconomical.

Korean Patent KR 10-1222874 B1 discloses a system and method for measuring a filled amount of a compressed gas based on the parameters of pressure and temperature. These values are captured by pressure and temperature sensors in a reference container which is provided between a gas storage container and a pressure container to be refueled. In order to indirectly determine the pressure and the temperature in the pressure container prior to the refueling process, the reference container is first filled with the compressed gas up to the maximum achievable loading pressure. The pressure container to be loaded is then filled from the reference container until an isothermal isostatic pressure is established. The pressure is measured in the reference container and passed on to a control unit. After filling the pressure container from the gas storage container, the pressure and the temperature in the reference container are measured again and supplied to the control unit. At the end of the refueling process, the control unit calculates the amount of gas refueled from these pressure and temperature values and calculates a corresponding sum of money to be paid.

European Patent EP 3 271 636 B1, corresponding to U.S. Pat. No. 10,591,112 B2, describes a method for filling pressure containers with a compressed gas, in particular hydrogen. The method is performed by using a filling station which includes a plurality of storage tanks for compressed gas and a line system for transporting gas from the storage tanks to the pressure containers by using a pressure equalization process or a plurality of pressure equalization processes. The line system has a first end at which the storage tanks are connected in parallel. At a second end of the line system, there is a transport line which is movably connected to the pressure container(s) to be filled. A first shut-off valve, a flow or pressure regulating member, and a second shut-off valve are connected in series between the first end and the second end of the line system. According to the method, both shut-off valves are closed at the end of the filling of a first pressure container and before the filling of a second pressure container, so that a reserve of compressed gas is enclosed in the line system between these two shut-off valves. That reserve of gas is used for refilling at least one of the pressure containers.

German Application DE 10 2019 120 242 A1 describes a method for determining a filling mass of a pressure container which has a container volume enclosed by a container wall. As such, the filling mass is determined using dimensional data of the pressure container measured at that pressure container.

U.S. Pat. No. 7,647,194 B1 describes a method for calculating the hydrogen temperature during vehicle refueling. The calculation is based on data on the ambient temperature, the static initial pressure, the static final pressure of a pressure meter, the added mass and the filling time.

European Patent EP 3 299 775 B1 describes a system for mobile calibration of a gas filling apparatus. Therein, a filling container accommodated in a measuring housing is filled with a high-pressure fuel gas by the gas filling apparatus and the weight of the fuel gas supplied is determined by using a scale. For the measuring process, a dry gas is introduced into the measuring housing to avoid condensation of moisture on the filling container which falsifies the measurement.

### SUMMARY OF THE INVENTION

It is accordingly an object of the invention to provide an apparatus and a method for determining an amount of compressed gas, which overcome the hereinafore-mentioned disadvantages of the heretofore-known apparatuses and methods of this general type and which enable precise determination of an amount of a compressed gas, in particular hydrogen gas, during withdrawal with little effort.

With the foregoing and other objects in view there is provided, in accordance with the invention, a measuring apparatus for determining an amount of compressed gas in a gas withdrawal from a compressed-gas reservoir, which includes a plurality of sub-reservoirs, which are capable of being tapped independently of one another, a gas pressure sensor, which is coupled, with respect to pressure, to each of the sub-reservoirs by measurement lines, a switching device, which is provided in the measurement lines and through the use of which the gas pressure sensor is connectable to each of the sub-reservoirs alternately in order to selectively measure a gas pressure in the sub-reservoir in question, and at least one temperature sensor for measuring a gas temperature, the temperature sensor being disposed at the location of the compressed-gas reservoir.

With the objects of the invention in view, there is also provided a device, in particular a tank vehicle or tank trailer, for storing and/or transporting compressed gas, having a compressed-gas reservoir, which includes a plurality of sub-reservoirs, which are capable of being tapped independently of one another, and having a measuring apparatus according to the invention.

With the objects of the invention in view, there is furthermore provided a device, in particular a tank vehicle, a tank trailer or a pressure container of a filling station, for storing and/or transporting compressed gas, having a compressed-gas reservoir, which includes a plurality of sub-reservoirs, which are capable of being tapped independently of one another, having a gas withdrawal manifold to which each of the sub-reservoirs is fluidically coupled via an associated branch line, and having a measuring apparatus according to the invention, each of the sub-reservoirs being associated with an automatic shut-off valve, which is provided in the branch line associated with the sub-reservoir in question and through the use of which the sub-reservoir in question is reversibly fluidically connectable to the gas withdrawal manifold and is fluidically disconnectable from the gas withdrawal manifold.

With the objects of the invention in view, there is additionally provided a method for determining an amount of compressed gas withdrawn from a compressed-gas reservoir, which includes a plurality of sub-reservoirs, which are capable of being tapped independently of one another, by using the measuring apparatus according to the invention, wherein, each time when withdrawing gas from one of the sub-reservoirs, immediately before the start of the gas withdrawal, an initial measurement value of the gas pressure and an initial measurement value of the gas temperature are measured in this sub-reservoir, immediately after the end of the gas withdrawal, a final measurement value of the gas pressure and a final measurement value of the gas temperature are measured in this sub-reservoir, wherein an amount of gas withdrawn from this sub-reservoir is calculated taking into account the initial measurement value and the final measurement value of the gas pressure and the initial measurement value und the final measurement value of the gas temperature and, for measuring the initial measurement value and the final measurement value of the gas pressure, the gas pressure sensor of the measuring apparatus is selectively connected to this sub-reservoir by using the switching device.

With the objects of the invention in view, there is also provided a method for calibrating the device according to the invention, wherein a reference tank is filled with a reference gas amount of a reference gas from one of the sub-reservoirs, the reference gas amount is determined by weighing the reference tank before and after the reference tank is filled with the reference gas, measurement values of the gas temperature in this sub-reservoir are captured by the at least one temperature sensor of the measuring apparatus before and after the reference tank is filled with the reference gas, measurement values of the gas pressure in this sub-reservoir are captured by the gas pressure sensor of the measuring apparatus before and after the reference tank is filled with the reference gas, an amount of gas withdrawn is calculated by a stored set of states formula taking into account the captured measurement values of the gas temperature and the gas pressure and compared to the reference amount of gas of the reference gas determined by weighing, and the set of states formula is adapted such that the calculated gas amount matches the reference gas amount of the reference gas determined by weighing.

With the objects of the invention in view, there is concomitantly provided a method for calibrating the device according to the invention, wherein a reference gas amount of a reference gas is filled from a reference tank into one of the sub-reservoirs, the reference gas amount is determined by weighing the reference tank before and after this sub-reservoir is filled with the reference gas, measurement values of the gas temperature in this sub-reservoir are captured by the at least one temperature sensor of the measuring apparatus before and after this sub-reservoir is filled with the reference gas, measurement values of the gas pressure in this sub-reservoir are captured by the gas pressure sensor of the measuring apparatus before and after this sub-reservoir is filled with the reference gas, an amount of gas supplied is calculated by a stored set of states formula taking into account the captured measurement values of the gas temperature and the gas pressure and compared to the reference gas amount of the reference gas determined by weighing, and the set of states formula is adapted such that the calculated gas amount matches the reference gas amount of the reference gas determined by weighing.

Advantageous embodiments and developments of the invention are set forth in the dependent claims and the following description.

The invention is based on a device for storing and/or transporting compressed gas, which is also generally referred to as a “tank apparatus” and which is formed, for example, by a tank vehicle, a tank trailer or by a pressure accumulator of a filling station. This tank apparatus includes a compressed-gas reservoir for receiving a compressed gas, this compressed-gas reservoir including a plurality of sub-reservoirs which are capable of being “tapped” independently of one another, i.e., are accessible for withdrawal of the compressed gas. Hereinafter, these sub-reservoirs are also referred to as “cascades”. For the purposes of the invention, each cascade may be formed by a single compressed-gas container. Preferably—especially for the transport of gases such as hydrogen gas stored and transported under high pressure—each cascade, however, is preferably itself formed by a bundle of a plurality of compressed-gas containers connected to one another with respect to pressure (fluidically).

Here and in the following, “connection” with respect to pressure or fluidic “connection” between two objects is generally understood to mean a connection, for example by a pipeline, which permits gas movement and thus pressure equalization between these objects. As a terminological distinction thereto, the devices provided for the (in particular reversible) establishment of such a “connection” with respect to pressure or fluidic “connection” are referred to as “coupling” with respect to pressure or fluidic “coupling.” For example, for the purposes of this terminological scheme, a pipeline laid between two objects and provided with a shut-off valve represents a coupling with respect to pressure or fluidic coupling regardless of the position of the shut-off valve, but only represents a connection with respect to pressure or fluidic connection when the shut-off valve is open. The verbs “couple” and “connect” are used accordingly.

The measuring apparatus according to the invention includes a gas pressure sensor which is coupled, with respect to pressure (fluidically), to each of the cascades by measurement lines. The measuring apparatus also includes a switching device, which is provided in the measurement lines and through the use of which the gas pressure sensor is connectable to each of the cascades alternately to selectively measure a gas pressure in the cascade in question. In particular, this switching device (hereinafter also referred to as a “multiplexer”) is operated such that at no time more than one cascade is connected, with respect to pressure, to the pressure sensor. The measuring apparatus also includes at least one temperature sensor for measuring a gas temperature in the compressed-gas reservoir being disposed at the location of the compressed-gas reservoir.

In principle, embodiments fall within the scope of the invention in which the measuring apparatus only has a single temperature sensor which measures a temperature in the compressed-gas reservoir or in its spatial environment as a reference value for the gas temperature. Preferably, however, the measuring apparatus includes a number of temperature sensors corresponding to the number of cascades, each of the temperature sensors being disposed at the location of the associated cascade for measuring a gas temperature of the cascade in question. As such, the or each temperature sensor is disposed, in particular directly, in the pressure chamber of the cascade or in a branch line which connects this cascade to a gas withdrawal manifold of the tank apparatus. In further embodiments of the invention, the measuring apparatus includes a plurality of temperature sensors per cascade, for example a respective temperature sensor for each of a plurality of pressure containers of a cascade. In this case, a (simple or weighted) average value is formed from the values of the plurality of temperature sensors of each cascade, so that an average temperature value is available for each cascade.

When the measuring apparatus is operated, taking into account supplied measurement values of the gas pressure and the gas temperature of at least one of the cascades at the start (i.e., immediately before the start) and at the end (i.e., immediately after the end) of a gas withdrawal from this cascade, the amount of gas withdrawn is calculated based on a predetermined set of states formula. In this respect, the set of states formula is preferably derived from a gas equation, i.e., a thermal state equation for ideal gases or—preferably—for real gases. In principle, for the purposes of the invention, this calculation of the gas amount may be performed manually. However, in a preferred embodiment, the measuring apparatus includes an electronic controller which is signally connected to the pressure sensor and the or each temperature sensor to obtain measurement values of the respective gas pressure and the gas temperature of the sub-reservoirs. As such, the electronic controller is configured to, taking into account supplied measurement values of the gas pressure and the gas temperature of at least one of the cascades at the start and at the end of a gas withdrawal, automatically calculate the gas amount withdrawn from this cascade.

The terms “immediately before the start of the gas withdrawal” and “immediately after the end of the gas withdrawal” mean that there is no change in the gas amount in the cascade affected by the gas withdrawal between the first pressure and temperature measurement and the start of the gas withdrawal or between the end of the gas withdrawal and the second pressure and temperature measurement (irrespective of the time interval between the first pressure and temperature measurement and the start of the gas withdrawal or between the end of the gas withdrawal and the second pressure and temperature measurement; in particular, a settling phase is preferably provided between the end of the gas withdrawal and the second pressure and temperature measurement, in which the pressure conditions stabilize in the cascade in question). The immediacy described above is also maintained if—in a preferred embodiment of the invention—a plurality of cascades are emptied completely or partially one after the other between a first measurement of the pressures and temperatures in all cascades and a second measurement of the pressures and temperatures in all cascades. As such, the gas withdrawal from at least one of the cascades may also take place in a plurality of temporally separated intervals.

Preferably, the electronic controller is also connected, with respect to control (in particular electrically), to the multiplexer. As such, the electronic controller is configured to, for measuring the gas pressure in one of the cascades, connect, with respect to pressure, the gas pressure sensor to the cascade in question by driving the multiplexer. Alternatively, in a further embodiment of the invention, the switching device has a manually operable switching mechanism through the use of which, for measuring the gas pressure in one of the sub-reservoirs, the gas pressure sensor is manually connectable to the sub-reservoir in question. In this case, the switching mechanism is provided with a sensor system which supplies the electronic controller with information on the sub-reservoir respectively provided with the gas pressure sensor.

The electronic controller of the measuring apparatus preferably includes a programmable component, e.g., a microprocessor or single-board computer, in which a software (firmware) implementing the functions of the electronic controller is installed in an executable manner. Alternatively, for the purposes of the invention, the electronic controller may also be formed by a non-programmable hardware circuit (e.g., in the form of an ASIC). Further alternatively, for the purposes of the invention, the electronic controller may be formed by a combination of programmable and/or non-programmable components.

The electronic controller is preferably integrated together with the gas pressure sensor and the multiplexer in a component which is also referred to as a set of states converter (SSC for short).

The device (tank apparatus) according to the invention includes the compressed-gas reservoir formed from the plurality of sub-reservoirs (cascades) and the measuring apparatus according to the invention described above, in particular in one of the embodiments described above.

In an advantageous embodiment, the device includes a gas withdrawal manifold to which each of the cascades is fluidically coupled via an associated branch line. As such, in each of the branch lines, an automatic shut-off valve (in particular in the form of a solenoid valve) is preferably provided, through the use of which the cascade in question is reversibly fluidically connectable to the gas withdrawal manifold and is fluidically disconnectable from the gas withdrawal manifold.

The method according to the invention for determining an amount of compressed gas withdrawn from the compressed-gas reservoir described above is performed by using the measuring apparatus according to the invention described above. The embodiments of the measuring apparatus therefore correspond to corresponding embodiments of the method, so that explanations on embodiments of the measuring apparatus may be applied analogously to embodiments of the method, and vice versa.

In the course of the amount determination method, for each gas withdrawal from one of the cascades, an initial measurement value of the gas pressure and an initial measurement value of the gas temperature are measured immediately before the start of the gas withdrawal. Furthermore, immediately after the end of the gas withdrawal, a final measurement value of the gas pressure and a final measurement value of the gas temperature are measured in this cascade. Taking into account the initial measurement value and the final measurement value of the gas pressure as well as the initial measurement value and the final measurement value of the gas temperature, a gas amount withdrawn from this cascade is calculated. In order to measure the initial measurement value and the final measurement value of the gas pressure, the gas pressure sensor of the measuring apparatus is selectively connected to this cascade by the multiplexer.

When calculating the amount of gas withdrawn from the cascade in question, a pressure-and/or temperature-dependent change in the volume of the cascade in question is preferably taken into account, for example based on characteristic data or formulae stored in the electronic controller.

In a variation of the method, the gas is withdrawn from the various cascades in a time-staggered manner, so that there is no simultaneous gas withdrawal from more than one cascade. Alternatively, the compressed gas is withdrawn from a plurality of cascades simultaneously. With a compressed gas withdrawal from a plurality of cascades, the amounts of gas withdrawn determined for each of the individual cascades are added together in both cases.

In the course of a first variation of the method according to the invention for calibrating the device, an external reference tank—which is in particular empty at the start of the calibration—is filled with a reference gas from a sub-reservoir (cascade) of the tank apparatus. In this respect, the reference tank is mounted on a scale by which the filled gas amount of the reference gas (reference gas amount) is captured by weighing (i.e., by determining the weight). Subsequently, the captured weight of the refilled reference gas amount is compared to the gas amount calculated—(in particular automatically by the measuring apparatus) based on measurement values of the gas pressure and the gas temperature and the geometric volume of the cascade.

An equally advantageous second variation of the method for calibrating the device is inverse to the previous one. In this alternative method variation, the device is calibrated not by emptying but by filling a sub-reservoir. For this purpose, the reference tank from which the device is filled is again mounted on a scale. The amount of gas now refueled is determined based on the weight and compared to the calculated amount of gas.

In both cases, the set of states formula used to calculate the amount of gas is adapted such that the calculated amount of gas matches the amount of gas of the reference gas determined by weighing.

The two variations of the calibration method described above may both be performed as a part of the method described above for determining an amount of compressed gas withdrawn, or independently thereof. If the volume and the change in volume of the cascades installed in the tank apparatus are not specified in associated container documents of the tank apparatus, they could be filtered out using the calibration method to determine the actual volume and the change in volume under pressure.

In the variations of the calibration method described above, nitrogen gas, for example, may be used as the reference gas as this gas is comparatively heavy, and measurement errors of the scale therefore have a comparatively small influence on the measurement of the gas amount. In addition, nitrogen is inert, easy to handle and inexpensive. Alternatively, for the purposes of the invention, the same type of gas to be refueled later as compressed gas, for example hydrogen gas, may also be used as the reference gas.

In addition to the reliable and accurate determination of an amount of the compressed gas taking into account the above-mentioned factors and the official requirements for calibration capability, embodiments of the invention also solve the problem of cost-intensive measuring instruments. In particular, Coriolis mass flow meters, which are an important cost driver in conventional tank apparatuses, are not necessary in the tank apparatus according to the invention and are therefore preferably not provided.

By replacing conventionally used Coriolis flow meters with the gas pressure sensor and the at least one temperature sensor, the energy demand of the measuring apparatus is also significantly reduced compared to conventional systems.

In addition, the measuring apparatus according to the invention advantageously solves problems of conventional systems regarding measurement inaccuracies from the use of a plurality of individual sensors.

The preferred automation of the measuring process reduces the risk of an incorrect determination of the amount of gas withdrawn as a result of human operating errors or misuse. Advantageously, the measuring apparatus according to the invention and the method according to the invention for determining an amount are calibratable as a result of high precision and tamper resistance.

Other features which are considered as characteristic for the invention are set forth in the appended claims.

Although the invention is illustrated and described herein as embodied in an apparatus and a method for determining an amount of compressed gas, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic diagram of a device for storing and/or transporting compressed gas, in particular hydrogen gas, having a compressed-gas reservoir which includes a plurality of sub-reservoirs (cascades) able to be tapped independently of one another, and having a measuring apparatus for determining the amount of compressed gas in a gas withdrawal from the compressed-gas reservoir; and

FIGS. 2 and 3 are block diagrams showing two variations of a method for calibrating the measuring apparatus.

### DETAILED DESCRIPTION OF THE INVENTION

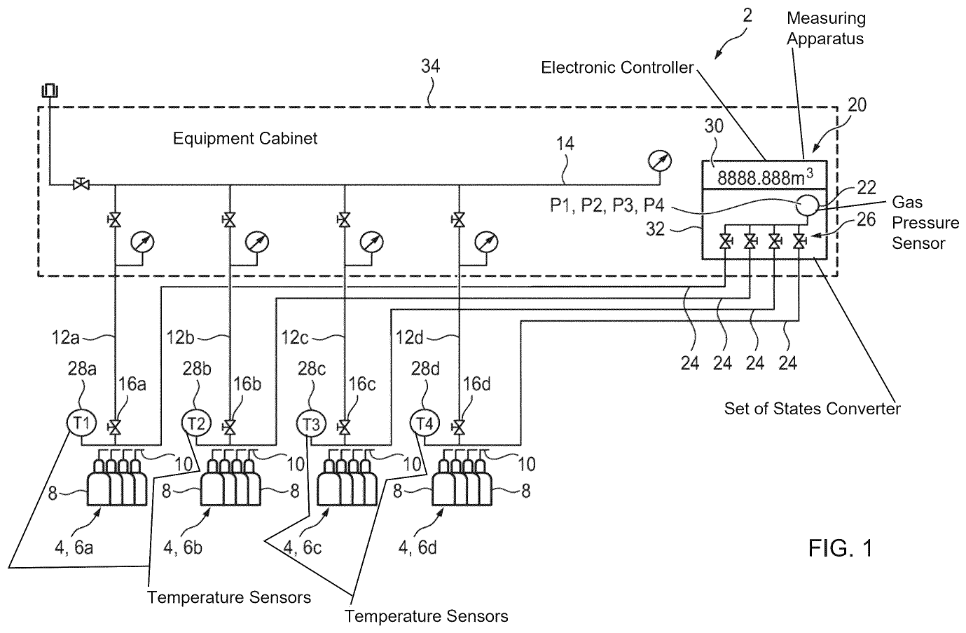

Referring now in detail to the figures of the drawings, in which parts and sizes corresponding to one another are always provided with the same reference numerals, and first, particularly, to FIG. 1 thereof, there is seen an exemplary embodiment of a device (tank apparatus) according to the invention which is formed by a tank truck 2, i.e., a (autonomous) tank vehicle or a tank trailer, on which a plurality of, in the example shown four, sub-reservoirs (cascades 6a, 6b, 6c, 6d), each having a plurality of compressed-gas containers 8, are fixedly mounted as a compressed-gas reservoir 4. Compressed-gas containers 8 belonging to the same cascade 6a-6d are each fixedly piped to one another, i.e., fixedly fluidly connected to one another by pipelines 10. Each of cascades 6a-6d is fluidically coupled to a gas withdrawal manifold 14 via an associated branch line 12a, 12b, 12c, 12d. In each of branch lines 12, a shut-off valve 16a, 16b, 16c, 16d (each in particular in the form of an electrically drivable solenoid valve or manual valve) is disposed, through the use of which the associated cascade 6a-6d may be reversibly fluidically connected to gas withdrawal manifold 14 and may be fluidically disconnected from gas withdrawal manifold 14. In particular, tank truck 2 is configured and used for the transport and storage of hydrogen gas.

Tank truck 2 is associated with a measuring apparatus 20 for determining the gas amount of the compressed gas withdrawn from compressed-gas reservoir 4. Measuring apparatus 20 includes a gas pressure sensor 22, which is coupled, with respect to pressure, to each of cascades 6a-6d by measurement lines 24.

Measuring apparatus 20 further includes a switching device (multiplexer 26) provided in measurement lines 24 and through the use of which gas pressure sensor 22 is connectable, with respect to pressure, to each of cascades 6a-6d to selectively measure a gas pressure P1, P2, P3, P4 in sub-reservoir 6a-6d in question. Here, by way of example, gas pressure P1 is associated with cascade 6a, gas pressure P2 with cascade 6b, gas pressure P3 with cascade 6c and gas pressure P4 with cascade 6d. Preferably, apart from multiplexer 26, no further shut-off measures are present in measurement lines 24, through the use of which fluidic connection of gas pressure sensor 22 to each of cascades 6a-6d could be interrupted or restricted.

Measuring apparatus 20 further includes a respective temperature sensor 28a, 28b, 28c, 28d for each of cascades 6a-6d. As such, each of temperature sensors 28a-28d is preferably disposed directly in one of gas pressure containers 8 of associated cascade 6a-6d in question or outside gas pressure container 8 in good thermal contact with the container wall to measure a gas temperature T1, T2, T3, T4 in cascade 6a-6d in question. As such, gas temperature T1 is associated with cascade 6a, temperature T2 with cascade 6b, gas temperature T3 with cascade 6c and gas temperature T4 with cascade 6d.

Finally, measuring apparatus 20 includes an electronic controller 30, which is formed by a microcontroller, for example. Electronic controller 30 is signally (in particular electrically) connected to gas pressure sensor 22 and each of temperature sensors 28a-28d and receives measurement values of gas pressures P1-P4 and gas temperatures T1-T4 as input variables from these sensors.

Electronic controller 30 is furthermore connected, with respect to control (in particular electrically), to multiplexer 26, so that electronic controller 30 may alternately and in each case selectively connect, with respect to pressure, gas pressure sensor 22 to each of cascades 6a-6d by appropriately driving multiplexer 26 to perform a measurement of gas pressure P1-P4 in the respectively connected cascade 6a-6d. Alternatively, multiplexer 26 is provided with a manually operable switching mechanism (manual switch) through the use of which a user may manually (but again alternately and in each case selectively) connect the individual cascades to gas pressure sensor 22. This manual switch is preferably provided with a sensor system (switch position sensor) which transmits information on the respectively provided cascade 6a-6d to electronic controller 30.

Gas pressure sensor 22, multiplexer 26 and electronic controller 30 are integrated in a component referred to as a set of states converter 32. Set of states converter 32 is again preferably installed in a closable equipment cabinet 34 of tank truck 2.

For refueling, i.e., the withdrawal of compressed gas from compressed-gas reservoir 4, cascades 6a-6d are preferably emptied one after the other. Thus, preferably, one of cascades 6a-6d is first largely emptied before it is closed again, and a switch to another, still full, cascade 6a-6d occurs. In a preferred embodiment of the method, the refueling process, i.e., the linking of cascades 6a-6d to gas withdrawal manifold 14 and the disconnecting of cascades 6a-6d from gas withdrawal manifold 6a-6d, as well as the switching between different cascades 6a-6d, is initiated manually by a user actuating shut-off valves 16a-16d. In this case, only the measurement of the amount of gas withdrawn during the refueling process takes place automatically.

For this purpose, a computer program (firmware) is installed in electronic controller 30 so as to be executable, which automatically performs a method for determining an amount of gas withdrawn from a cascade 6a-6d as follows:

Immediately before the start and immediately after the end of the gas withdrawal from at least one of cascades 6a-6d, the respective gas pressure P1-P4 and the respective gas temperature T1-T4 are measured for each of cascades 6a-6d. For the pressure measurement, electronic controller 30 connects each of cascades 6a-6d to gas pressure sensor 22 one after the other by driving multiplexer 26 correspondingly. In the case of a gas withdrawal from a plurality of cascades 6a-6d, the first measurement of temperatures T1-T4 and pressures P1-P4 preferably takes place before the start of the gas withdrawal from the first cascade 6a-6d, while the second measurement of temperatures T1-T4 and pressures P1-P4 preferably takes place after the end of the gas withdrawal from the last cascade 6a-6d.

From the corresponding measurement values of gas pressure P1-P4 and gas temperature T1-T4 in the cascade 6a-6d in question, electronic controller 30 calculates the gas amounts contained in cascades 6a-6d before the gas withdrawal and after the gas withdrawal using a stored state equation, preferably a state equation for real gases. From the difference (also referred to as the “set of states formula”) of the gas amounts calculated in this manner, electronic controller 30 then calculates the gas amount withdrawn from each of cascades 6a-6d. In the case of a gas withdrawal from a plurality of cascades 6a-6d, the gas amounts respectively withdrawn from the individual cascades 6a-6d are totaled by electronic controller 30.

As a parameter in this calculation, electronic controller 30 takes into account the volume of cascade 6a-6d in question. Information on the respective volume of cascades 6a-6d and preferably also on the change in this volume as a function of gas pressure P1-P4 and/or gas temperature T1-T4 is available, for example, from container documents associated with tank truck 2. During commissioning of measuring apparatus 20, these volume data are entered and stored in electronic controller 30. The volume data are present, for example, in the form of characteristic curves or characteristic data tables of the respective volume of the individual compressed-gas containers 8 as a function of the temperature and/or the gas pressure. Alternatively, a reference volume determined for a predetermined reference temperature and a predetermined reference pressure is input as volume data for each compressed-gas container 8 or each cascade 6a-6d. In the latter case, electronic controller 30 preferably calculates the temperature- and/or pressure-dependent volume change from the stored reference volumes and the obtained measurement values of gas pressure P1-P4 and gas temperature T1-T4 based on predetermined correction formulae.

All measurement values included in the calculation and all calculations are recorded by electronic controller 30 (unchangeably) in an electronic logbook and provided with a sequential number to make the measuring method tamper-proof. Then, the calculated amount of the compressed gas refueled is optionally used to issue a delivery note (manually or automatically).

The measurements required for determining the amount of gas withdrawn are preferably initiated fully automatically (without interaction with a user).

For this purpose, measuring apparatus 20 includes, in a convenient embodiment, a coupling sensor (not explicitly shown), for example an inductive sensor, which detects the coupling of a hose line to gas withdrawal manifold 14. As such, electronic controller 30 is configured to automatically start a first measuring process for determining gas pressures P1-P4 and gas temperatures T1-T4 before the gas withdrawal when the coupling sensor signals coupling of a hose line. Furthermore, electronic controller 30 is configured to automatically start a second measuring process for determining gas pressures P1-P4 and gas temperatures T1-T4 after the gas withdrawal when the coupling sensor signals decoupling of the hose line.

In an alternative embodiment, measuring apparatus 20 includes a door opening sensor (likewise not explicitly shown) which detects the opening of a door of equipment cabinet 34. In this embodiment, electronic controller 30 is configured to automatically start the first measuring process when the door opening sensor signals opening of equipment cabinet 34. Electronic controller 30 is further configured to automatically start the second measuring process when the door opening sensor signals closing of equipment cabinet 34. In order to prevent misuse, the closing of equipment cabinet 34 is preferably blocked by electronic controller 30 when and as long as at least one of shut-off valves 16a-16d is open.

In a further embodiment of measuring apparatus 20, the two measuring processes are performed by electronic controller 30 when a user releases or terminates the refueling process by operating a corresponding command generator.

In a further embodiment of the invention, electronic controller 30 serves not only to determine the amount of gas withdrawn, but also to automatically control the refueling process. In this embodiment, electronic controller 30 is connected, with respect to control (in particular electrically), to each of shut-off valves 16a-16d, so that electronic controller 30, by appropriately driving one of the shut-off valves 16a-16d, may automatically fluidically connect the associated cascade 6a-6d to gas withdrawal manifold 14 and may fluidically disconnect it from gas withdrawal manifold 14. Electronic controller 30 automatically switches to another (still filled) cascade 6a-6d, in particular when required, after a cascade 6a-6d was emptied. Electronic controller 30 automatically measures gas pressure P1-P4 and gas temperature T1-T4 at the respective cascade 6a-6d concerned both before the automatic connection of one of the cascades 6a-6d to gas withdrawal manifold 14 and after the automatic disconnection of cascade 6a-6d from gas withdrawal manifold 6a-6d.

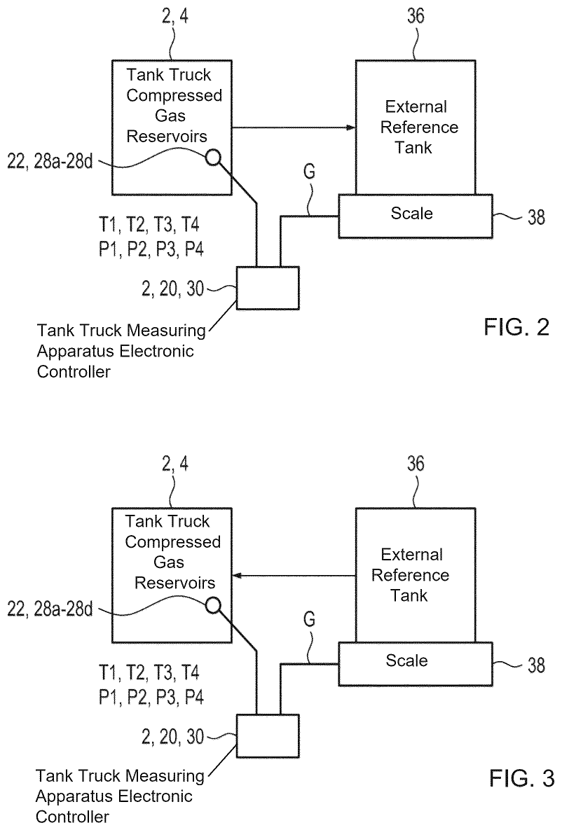

In particular in the case in which the (container) volume of the individual cascades 6a-6d required for calculating the amount of gas withdrawn cannot be determined, or cannot be determined with sufficient accuracy, from existing container documents, this volume may also be determined by using a calibration method which is shown in two variations in FIGS. 2 and 3.

According to the first variation of the calibration method shown in FIG. 2, an external reference tank 36—which is empty in particular at the start of the calibration—is filled from the cascade 6a-6d to be calibrated with a reference gas, wherein gas pressure P1-P4 and gas temperature T1-T4 at cascade 6a-6d in question are determined before and after the gas withdrawal in accordance with the above measuring method, and a value for the amount of gas withdrawn is calculated therefrom. As such, reference tank 36 is mounted on a scale 38 with which the filled gas amount of the reference gas (reference gas amount G) is determined by weighing.

According to the second variation of the calibration method shown in FIG. 3, the cascade 6a-6d to be calibrated is filled with the reference gas from external reference tank 36, wherein gas pressure P1-P4 and gas temperature T1-T4 are again determined according to the above measuring method at the cascade 6a-6d in question before and after the gas supply, and a value for the gas amount supplied to cascade 6a-6d is calculated therefrom. Reference tank 36 is in turn mounted on a scale 38, with which reference gas amount G withdrawn from reference tank 36 is determined.

In both variations of the calibration method, reference gas amount G is compared to the gas amount calculated by measuring apparatus 20. If necessary, the volume data stored in electronic controller 30 are corrected so that the calculated gas amount is adapted to reference gas amount G determined by weighing. This adaptation is preferably carried out automatically by electronic controller 30, to which the measurement value of reference gas amount G determined by scale 38 is supplied manually or automatically for this purpose. In an alternative embodiment of the calibration method, scale 38 supplies the measured weight of reference tank 36 to electronic controller 30 before and after supply or withdrawal of the reference gas. In this case, reference gas amount G is determined by electronic controller 30 based on the supplied measured weight values.

The calibration method described above may also be used for regular inspection (re-calibration) of measuring apparatus 20. Nitrogen gas in particular is used as the reference gas.

Embodiments of the invention described above in particular have the following features:
Determining an amount during the withdrawal of a compressed gas is carried out with the aid of temperature sensors and a gas pressure sensor; a flow meter is not required and is therefore preferably not used for the purposes of the method and the device.
The gas amount is preferably calculated taking into account the change in volume in the sub-reservoirs (i.e., the individual compressed-gas containers or cascades) of the tank apparatus as a function of the gas pressure and/or the gas temperature.
Measurement errors are reduced by use of a single gas pressure sensor and preferably at least one temperature sensor per cascade.
If one of the cascades is itself formed from a plurality of compressed-gas containers, the compressed-gas containers belonging to this cascade are preferably fixedly piped to one another.
The individual cascades may be connected, with respect to pressure, individually to the gas pressure sensor by an automatic valve (in particular a solenoid valve) via a switching unit (multiplexer), so that the pressure can be determined successively for each cascade with the one gas pressure sensor. In this case, the pressure is preferably recorded at measurement lines which—apart from the multiplexer—cannot be closed, so that the measurement results cannot be tampered with. In particular, by using the single gas pressure sensor at the measurement lines, the same measurement inaccuracy is always produced so that taking this measurement inaccuracy into account is facilitated.
With regard to calibration capability, it should be noted that the sensors must be calibrated at regular intervals. Thus, the complexity of the measuring apparatus according to the invention is low since it only has a comparatively small number of sensors (namely, in total, only one gas pressure sensor used for the measurement, irrespective of the number of cascades, and preferably only one temperature sensor per cascade).
The preferably fixedly installed cylinder bundles in the individual cascades and their piping, with the aid of an initial comparison of the measurement results to the weight of the tank apparatus or a functional part of the tank apparatus (tank vehicle/individual cylinder bundle/individual cascade) in the empty and full state, favors the achievement of an accuracy of the measurement results up to the degree of calibration capability.
The temperature measurement preferably occurs directly in at least one compressed-gas container per cascade. For this purpose, a thermowell with the associated temperature sensor is preferably mounted in the corresponding compressed-gas container. As such, the displaced volume is negligible.
The gas amount of compressed gas withdrawn is determined, in particular, based on the given volume of the cascade from which the gas is withdrawn and based on the measured gas pressure and the measured gas temperature in this cascade. In this respect, only one gas pressure sensor is employed. The gas pressures in the various cascades are measured successively by using a changeover valve (multiplexer). At the same time, the gas temperatures are measured in the cascades in question.
Calculation of the gas amount is preferably accomplished using a real gas equation. Correction factors for taking into account the change in volume as a function of the pressure and/or the temperature are included in the calculation.

The measuring method and the associated device (tank apparatus) have the following advantages, at least in some embodiments of the invention:
High measuring accuracy: The measurement of the compressed gas via pressure and temperature with the calculation via the real gas equation, the given volume and the correction via the change in volume is a good prerequisite for an accurate measurement. The measuring accuracy is promoted by the use of a single pressure meter, so that only the measuring errors of this one pressure meter, and not the measuring errors of several meters, have to be taken into account.
High cost-effectiveness: High cost-effectiveness of the measuring method and the associated tank apparatus is achieved in particular in that the number and type of sensors save acquisition costs compared to conventional systems (in particular those with Coriolis flow meters). At the same time, the low energy demand of the measuring apparatus (especially compared to measuring apparatuses with Coriolis flow meters) ensures further savings. If the sensors need to be recalibrated, the small number of sensors is conducive to a fast and thus cost-effective process. Due to its simplicity, the measuring apparatus according to the invention also enables unproblematic retrofitting in existing tank apparatuses, which considerably reduces acquisition costs.
Avoidance of human measurement errors: The measurement of the amount of gas withdrawn described above can be automated simply and is preferably also performed fully automatically without interaction with human users, so that the risk of measurement errors due to incorrect operation or misuse is reduced.
Calibration capability through accuracy and tamper resistance: The measurement accuracy described above, together with the tamper resistance, results in a calibratable system. The tamper resistance is ensured by high measuring reliability and data security. The measuring reliability is provided in particular by the fixed piping of the pressure containers within the cascades, the measurement lines which can only be shut off in the set of states converter, and the avoidance of human measuring errors by automated measurement. Data security is ensured by storing data and measurements with a serial number in a logbook, so that these data can no longer be changed.
Simple and compact measuring apparatus: The measuring method and the associated device (tank apparatus) are able to be implemented in a space-saving and weight-saving manner. The measuring method and the associated device may also be easily scalable, quickly and easily retrofitted and (unlike the Coriolis measurement only functioning precisely in a limited range of the flow velocity) independent of the measuring dynamics.

The invention will be particularly clear from the exemplary embodiments described above but is not limited to these exemplary embodiments. Instead, further embodiments of the invention may be derived from the claims and the above description.

The following is a summary list of reference numerals and the corresponding structure used in the above description of the invention:

2 Tank truck
4 Compressed-gas reservoir
6a-6d Cascade
8 Compressed-gas container

### 10 Pipeline

12a-12d Branch line
14 Gas withdrawal manifold
16a-16d Shut-off valve
20 Measuring apparatus
22 Gas pressure sensor
24 Measurement lines

### 26 Multiplexer

28a-28d Temperature sensor
30 Electronic controller
32 Set of states converter
34 Equipment cabinet
36 Reference tank

### 38 Scale

P1-P4 Gas pressure
T1-T4 Gas temperature
G Reference gas amount

1. A measuring apparatus for determining an amount of compressed gas in a gas withdrawal from a compressed-gas reservoir having a plurality of sub-reservoirs capable of being tapped independently of one another, the measuring apparatus comprising:
measurement lines;
a gas pressure sensor coupled with respect to pressure to each of the sub-reservoirs by said measurement lines;
a switching device provided in said measurement lines for alternately connecting said gas pressure sensor to each of the sub-reservoirs to selectively measure a gas pressure in respective sub-reservoirs; and
at least one temperature sensor for measuring a gas temperature, said at least one temperature sensor being disposed at a location of the compressed-gas reservoir.

2. The measuring apparatus according to claim 1, wherein said at least one temperature sensor includes a number of temperature sensors corresponding to a number of the sub-reservoirs, each of said temperature sensors being disposed at a location of an associated sub-reservoir for measuring a gas temperature of the associated sub-reservoir.

3. The measuring apparatus according to claim 2, wherein each of said temperature sensors is disposed in a gas chamber of the associated sub-reservoir or in a branch line through which the respectively associated sub-reservoir is fluidically coupled to a gas withdrawal manifold.

4. The measuring apparatus according to claim 1, which further comprises:
an electronic controller connected for signal transmission to said gas pressure sensor and to said at least one temperature sensor to obtain measurement values of respective gas pressures and of respective gas temperatures of the sub-reservoirs;
said electronic controller configured to take into account supplied measurement values of the gas pressure and of the gas temperature of at least one of the sub-reservoirs and to calculate the amount of gas withdrawn from the at least one sub-reservoir immediately before a start and immediately after an end of a gas withdrawal.

5. The measuring apparatus according to claim 4, wherein said electronic controller is connected for control to said switching device provided in said measurement lines, said electronic controller configured to measure the gas pressure in one of the sub-reservoirs by selectively connecting said gas pressure sensor to the one sub-reservoir with respect to pressure by driving said switching device.

6. The measuring apparatus according to claim 4, wherein said switching device has a manually operable switching mechanism for manually connecting said gas pressure sensor to one of the sub-reservoirs for measuring the gas pressure in the one sub-reservoir, said switching mechanism having a sensor system supplying said electronic controller with information on the sub-reservoir connected to said gas pressure sensor.

7. A device or tank vehicle or tank trailer for at least one of storing or transporting compressed gas, the device comprising:
a compressed-gas reservoir having a plurality of sub-reservoirs capable of being tapped independently of one another; and
a measuring apparatus according to claim 1.

8. A device or tank vehicle or tank trailer or pressure container of a filling station for at least one of storing or transporting compressed gas, the device comprising:
a compressed-gas reservoir having a plurality of sub-reservoirs capable of being tapped independently of one another;
a gas withdrawal manifold;
branch lines each fluidically coupling a respective one of said sub-reservoirs to said gas withdrawal manifold;
a measuring apparatus according to claim 4; and
automatic shut-off valves each disposed in a respective one of said branch lines and each associated with a respective one of said sub-reservoirs for reversibly fluidically connecting said respective one of said sub-reservoirs to said gas withdrawal manifold and fluidically disconnecting said respective one of said sub-reservoirs from said gas withdrawal manifold.

9. The device according to claim 7, wherein each of said sub-reservoirs includes a plurality of pressure containers being fluidically fixedly connected to one another.

10. The device according to claim 8, wherein each of said sub-reservoirs includes a plurality of pressure containers being fluidically fixedly connected to one another.

11. A method for determining an amount of compressed gas withdrawn from a compressed-gas reservoir having a plurality of sub-reservoirs capable of being tapped independently of one another, the method comprising:
using the measuring apparatus according to claim 1 upon each gas withdrawal from one of the sub-reservoirs;
immediately before a start of the gas withdrawal, measuring an initial measurement value of the gas pressure and an initial measurement value of the gas temperature in the one sub-reservoir;
immediately after an end of the gas withdrawal, measuring a final measurement value of the gas pressure and a final measurement value of the gas temperature in the one sub-reservoir;
calculating an amount of gas withdrawn from the one sub-reservoir by taking into account the initial measurement value and the final measurement value of the gas pressure and the initial measurement value und the final measurement value of the gas temperature; and
using said switching device to selectively connect said gas pressure sensor of the measuring apparatus to the one sub-reservoir, for measuring the initial measurement value and the final measurement value of the gas pressure.

12. The method according to claim 11, which further comprises taking at least one of a pressure-dependent change or a temperature-dependent change in a volume of the one sub-reservoir into account when calculating the gas amount withdrawn from the one sub-reservoir.

13. The method according to claim 11, which further comprises withdrawing the gas from the sub-reservoirs in a time-staggered manner.

14. A method for calibrating the device according to claim 7, the method comprising:
filling a reference tank with a reference gas amount of a reference gas from one of the sub-reservoirs;
determining the reference gas amount by weighing the reference tank before and after filling the reference tank with the reference gas;
using said at least one temperature sensor of the measuring apparatus to capture measurement values of the gas temperature in the one sub-reservoir before and after filling the reference tank with the reference gas;
using said gas pressure sensor of the measuring apparatus to capture measurement values of the gas pressure in the one sub-reservoir before and after filling the reference tank with the reference gas;
calculating an amount of gas withdrawn by using a stored set of state formulas taking the captured measurement values of the gas temperature and the gas pressure into account, and comparing the calculated amount of gas withdrawn to the reference amount of gas of the reference gas determined by weighing; and
adapting the set of state formulas to cause the calculated gas amount to match the reference gas amount of the reference gas determined by weighing.

15. A method for calibrating the device according to claim 8, the method comprising:
filling a reference tank with a reference gas amount of a reference gas from one of the sub-reservoirs;
determining the reference gas amount by weighing the reference tank before and after filling the reference tank with the reference gas;
using said at least one temperature sensor of the measuring apparatus to capture measurement values of the gas temperature in the one sub-reservoir before and after filling the reference tank with the reference gas;
using said gas pressure sensor of the measuring apparatus to capture measurement values of the gas pressure in the one sub-reservoir before and after filling the reference tank with the reference gas;
calculating an amount of gas withdrawn by using a stored set of state formulas taking the captured measurement values of the gas temperature and the gas pressure into account, and comparing the calculated amount of gas withdrawn to the reference amount of gas of the reference gas determined by weighing; and
adapting the set of state formulas to cause the calculated gas amount to match the reference gas amount of the reference gas determined by weighing.

16. A method for calibrating the device according to claim 7, the method comprising:
filling a reference gas amount of a reference gas from a reference tank into one of the sub-reservoirs;
determining the reference gas amount by weighing the reference tank before and after filling the one sub-reservoir with the reference gas;
using said at least one temperature sensor of the measuring apparatus to capture measurement values of the gas temperature in the one sub-reservoir before and after filling the one sub-reservoir with the reference gas;
using said gas pressure sensor of the measuring apparatus to capture measurement values of the gas pressure in the one sub-reservoir before and after filling the one sub-reservoir with the reference gas;
calculating an amount of gas supplied by using a stored set of state formulas taking the captured measurement values of the gas temperature and the gas pressure into account, and comparing the calculated amount of gas supplied to the reference gas amount of the reference gas determined by weighing; and
adapting the set of state formulas to cause the calculated gas amount to match the reference gas amount of the reference gas determined by weighing.

17. A method for calibrating the device according to claim 8, the method comprising:
filling a reference gas amount of a reference gas from a reference tank into one of the sub-reservoirs;
determining the reference gas amount by weighing the reference tank before and after filling the one sub-reservoir with the reference gas;
using said at least one temperature sensor of the measuring apparatus to capture measurement values of the gas temperature in the one sub-reservoir before and after filling the one sub-reservoir with the reference gas;
using said gas pressure sensor of the measuring apparatus to capture measurement values of the gas pressure in the one sub-reservoir before and after filling the one sub-reservoir with the reference gas;
calculating an amount of gas supplied by using a stored set of state formulas taking the captured measurement values of the gas temperature and the gas pressure into account, and comparing the calculated amount of gas supplied to the reference gas amount of the reference gas determined by weighing; and
adapting the set of state formulas to cause the calculated gas amount to match the reference gas amount of the reference gas determined by weighing.

18. The method according to claim 14, which further comprises using nitrogen gas as the reference gas.

19. The method according to claim 15, which further comprises using nitrogen gas as the reference gas.

20. The method according to claim 16, which further comprises using nitrogen gas as the reference gas.

21. The method according to claim 17, which further comprises using nitrogen gas as the reference gas.
